(19) United States
(12) Patent Application Publication
(10) Pub. No.: US 2020/0134716 A1
(43) Pub. Date: Apr. 30, 2020

(54) SYSTEMS AND METHODS FOR DETERMINING CREDIT WORTHINESS OF A BORROWER

(71) Applicant: FLINKS TECHNOLOGY INC., Montreal (CA)

(72) Inventors: Karim LAHRICHI, Anjou (CA); Julien DUBÉ-COUSINEAU, Montreal (CA); Ayoub HANZOULI, Laval (CA); Frederick LAVOIE, Montreal (CA); Olivier BLAIS, Montreal (CA); Jonathan GAMBLE, Toronto (CA)

(21) Appl. No.: 16/665,282

(22) Filed: Oct. 28, 2019

Related U.S. Application Data
(60) Provisional application No. 62/752,118, filed on Oct. 29, 2018.

(51) Int. Cl. G06Q 40/02; G06N 20/00

(52) U.S. Cl. CPC G06Q 40/025; G06N 20/00

(57) ABSTRACT

There is disclosed a method and system for determining the credit worthiness of a borrower. The method comprises receiving a loan application from a prospective borrower. Transaction history for the prospective borrower is retrieved. A category is determined for each transaction in the transaction history. Transaction data metrics are determined for each category. A first machine learning algorithm (MLA) uses the transaction data metrics to predict a likelihood that the loan application will be approved. A second MLA uses the transaction data metrics to predict a likelihood that the loan will be repaid. The loan is approved or denied based on the predicted likelihoods.

### CROSS-REFERENCE TO RELATED APPLICATIONS

This application claims the benefit of and priority to U.S. Provisional Patent Application No. 62/752,118, filed on Oct. 29, 2018, and entitled “Systems and Methods for Determining Credit Worthiness of a Borrower,” which is incorporated by reference herein in its entirety.

### BACKGROUND

A lender may wish to assess the risk that the prospective borrower will default on a loan. The lender's profitability may be tied to their ability to forecast the probability that loans will be repaid. If the lender could more accurately predict the likelihood that a prospective borrower would repay a loan, the lender could increase their profitability.

Many processes for loan approvals are currently data driven to some degree, yet still involve a significant amount of manual labor. Moreover, there are few, if any, industry standards that govern the methodologies to be employed for approving loans. The combination of a continued reliance on manual input and the lack of standardization of approval processes can lead to poor decisions being made by lenders when evaluating loan applications from prospective borrowers. Further, these and other factors may contribute to delays between the time a loan application is submitted and the time loan funds are disbursed. Ethical issues may also be raised in processes where various types of information, which may include sensitive personal data, are captured and manually evaluated by personnel.

### SUMMARY

A prospective borrower's transaction history may be useful for predicting the likelihood that the prospective borrower will repay a loan. The transaction history can include payments that the prospective borrower has made (such as purchases) and/or payments that the prospective borrower has received (such as income). The transaction history may include credit card transactions, bank account transactions, and/or any other type of financial transactions.

The transactions history of a prospective borrower may be retrieved, such as from the prospective borrower's bank, credit card provider, etc. After retrieving the transaction history, the transactions in the transaction history may be categorized. For example each of a prospective borrower's payments to restaurants could be labeled as belonging to a “dining” category. Other exemplary categories may include: loan payments, insurance, utilities, telecom payments, debits, credits, payroll, employment income, etc. The categorized transactions may be used to determine various metrics. The metrics may include a sum of purchase amounts for each category and/or a count of transactions in each category.

The metrics and/or other data regarding the prospective borrower may be input to a machine learning algorithm (MLA). The MLA may output a predicted likelihood that the loan will be granted. The metrics and/or other data regarding the prospective borrower may be input to another MLA that predicts the likelihood that the prospective borrower will repay the loan. Various rules, such as rules that are specific to a lender, may be applied to the metrics and/or other data regarding the prospective borrower. Based on the results of the MLAs and the rules, a recommendation may be output and/or the loan application may be approved or denied. The recommendation may indicate whether the loan application should be approved. The recommendation may indicate reasons why the loan application should be approved and/or why the loan application should be denied.

According to a first broad aspect of the present technology, there is provided a method comprising: receiving, from a user, a request for a loan, wherein the request comprises a loan amount; retrieving a description of a plurality of transactions performed by the user; determining, for each transaction of the plurality of transactions, one of a plurality of categories corresponding to the respective transaction; determining, for each category of the plurality of categories, a total amount spent corresponding to the respective category and a total amount of transactions corresponding to the respective category; determining, by a first machine learning algorithm (MLA) and based on the loan amount, the total amount spent in each category, and the total amount of transactions for each category, a predicted likelihood that the loan will be approved, wherein the first MLA was trained based on loan data corresponding to a plurality of users and transaction data corresponding to the plurality of users; determining, by a second MLA and based on the loan amount, the total amount spent in each category, and the amount of transactions for each category, a predicted likelihood that the loan will be repaid, wherein the second MLA was trained based on the loan data corresponding to the plurality of users and the transaction data corresponding to the plurality of users; determining whether to approve the request for the loan based on the predicted likelihood that the loan will be approved and the predicted likelihood that the loan will be repaid; and outputting an indication of whether the loan was approved.

In some implementations of the method, the description of the plurality of transactions comprises a description of bank account transactions.

In some implementations of the method, the description of the plurality of transactions comprises a description of credit card transactions.

In some implementations of the method, the description of the plurality of transactions comprises an indication of a merchant for each transaction in the transaction history.

In some implementations of the method, determining the one of the plurality of categories corresponding to each transaction comprises determining, based on the indication of the merchant of the respective transaction, a category of the respective transaction.

In some implementations of the method, determining the one of the plurality of categories corresponding to each transaction comprises applying one or more regular expression (regex) rules to the description of each transaction of the plurality of transactions.

In some implementations of the method, the loan data corresponding to the plurality of users comprises a description of a plurality of loans, and wherein the description of each loan of the plurality of loans comprises an identifier of a recipient of the loan, an amount of the loan, and an indication of a status of the loan.

In some implementations of the method, the method further comprises determining to approve the request for the loan after determining that the predicted likelihood that the loan will be approved is above a pre-determined threshold likelihood.

In some implementations of the method, the method further comprises determining to approve the request for the loan after determining that the predicted likelihood that the loan will be repaid is above a pre-determined threshold likelihood.

In some implementations of the method, the method further comprises applying a pre-determined merchant-specific rule to the description of the plurality of transactions performed by the user.

In some implementations of the method, the method further comprises denying the request for the loan after determining that the merchant-specific rule is violated.

In some implementations of the method, the first MLA comprises a plurality of MLAs, and wherein determining the predicted likelihood that the loan will be approved comprises determining an average of the output of each of the plurality of MLAs.

In some implementations of the method, the second MLA comprises a plurality of MLAs, and wherein determining the predicted likelihood that the loan will be repaid comprises determining an average of the output of each of the plurality of MLAs.

According to another broad aspect of the present technology, there is provided a method comprising: receiving, from a user, a request for a loan, wherein the request comprises a loan amount; retrieving a description of a plurality of transactions performed by the user; determining, for each transaction of the plurality of transactions, one of a plurality of categories corresponding to the respective transaction; determining, for each category of the plurality of categories, a total amount spent corresponding to the respective category and a total amount of transactions corresponding to the respective category; determining, by a first machine learning algorithm (MLA) and based on the loan amount, the total amount spent in each category, and the total amount of transactions for each category, a predicted likelihood that the loan will be approved, wherein the first MLA was trained based on loan data corresponding to a plurality of users and transaction data corresponding to the plurality of users; determining, by a second MLA and based on the loan amount, the total amount spent in each category, and the amount of transactions for each category, a predicted likelihood that the loan will be repaid, wherein the second MLA was trained based on the loan data corresponding to the plurality of users and the transaction data corresponding to the plurality of users; determining, based on the predicted likelihood that the loan will be approved and the predicted likelihood that the loan will be repaid, a recommendation to approve or deny the loan; and outputting for display the recommendation.

In some implementations of the method, the method further comprises determining a feature importance ranking for the first or second MLA; and outputting, based on the feature importance ranking, an explanation for the recommendation.

In some implementations of the method, the method further comprises filtering out loan applications that were denied from the loan data corresponding to the plurality of users, thereby generating filtered loan data, and wherein the second MLA was trained using the filtered loan data.

According to another broad aspect of the present technology, there is provided a method for training an MLA to predict the likelihood that a loan will be repaid, the method comprising retrieving historic loan data corresponding to a plurality of users, each entry in the historic loan data indicating a loan amount, a status of the loan, and an identifier of a user of the plurality of users; retrieving historic transaction data corresponding to the plurality of users, each transaction in the historic transaction data indicating an amount of the respective transaction and a description of the respective transaction; determining, for each transaction in the historic transaction data, a category, of a plurality of categories, corresponding to the respective transaction, thereby generating categorized historic transaction data; determining, based on the categorized transaction data, transaction data metrics for each user of the plurality of users, wherein the transaction data metrics comprise a count of transactions and a sum of transaction amounts for each category of the plurality of categories; and training, based on the historic loan data and the transaction data metrics, the MLA.

In some implementations of the method, the MLA receives as input a loan amount and transaction metrics corresponding to a prospective borrower and outputs the predicted likelihood that the loan will be repaid. In some implementations of the method, the method further comprises

In some implementations of the method, the method further comprises grouping, based on transaction descriptions, transactions in the historic transaction data.

In some implementations of the method, a group of transactions correspond to a same retailer, and the method further comprises labeling each transaction in the group of transactions with a same category.

Various implementations of the present technology provide a non-transitory computer-readable medium storing program instructions for executing one or more methods described herein, the program instructions being executable by a processor of a computer-based system.

Various implementations of the present technology provide a computer-based system, such as, for example, but without being limitative, an electronic device comprising at least one processor and a memory storing program instructions for executing one or more methods described herein, the program instructions being executable by the at least one processor of the electronic device.

In the context of the present specification, unless expressly provided otherwise, a computer system may refer, but is not limited to, an “electronic device,” a “computing device,” an “operation system,” a “system,” a “computer-based system,” a “computer system,” a “network system,” a “network device,” a “controller unit,” a “monitoring device,” a “control device,” a “server,” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (e.g., CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first,” “second,” “third,” etc. have been used as adjectives only for the purpose of allowing for distinction between the nouns that they modify from one another, and not for the purpose of describing any particular relationship between those nouns.

Additional and/or alternative features, aspects and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a block diagram of an example computing environment in accordance with various embodiments of the present technology;

FIG. 2 is a diagram of a system for evaluating a loan application in accordance with various embodiments of the present technology;

FIG. 3 is a diagram of a system for training machine learning algorithms (MLAs) in accordance with various embodiments of the present technology;

FIGS. 4A-D illustrate a flow diagram of a method for evaluating loan applications in accordance with various embodiments of the present technology;

FIG. 5 illustrates an example of transaction history data in accordance with various embodiments of the present technology;

FIG. 6 illustrates an example of loan history data in accordance with various embodiments of the present technology;

FIG. 7 illustrates an example of a loan report output in accordance with various embodiments of the present technology; and

FIG. 8 illustrate a flow diagram of a method for generating synthetic loan history data in accordance with various embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that one or more modules may include for example, but without being limitative, computer program logic, computer program instructions, software, stack, firmware, hardware circuitry, or a combination thereof.

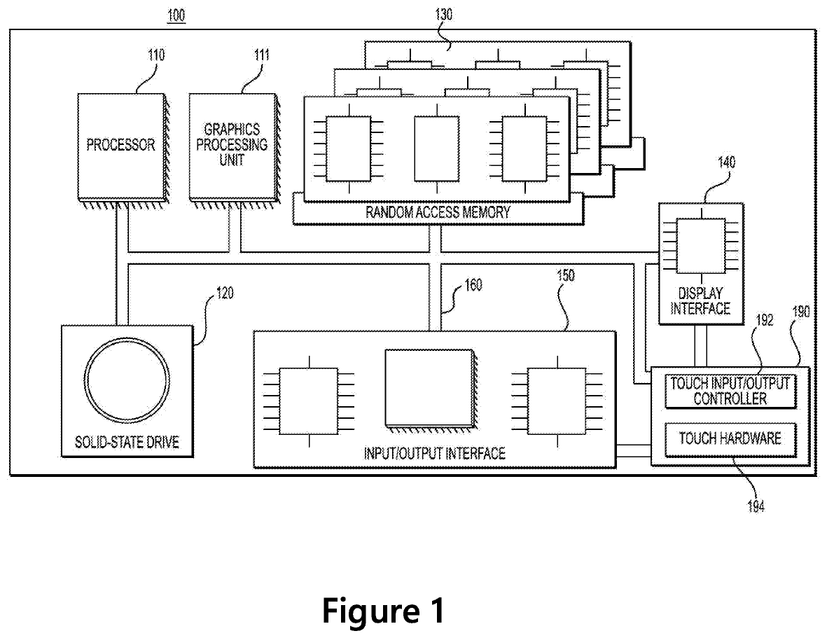

FIG. 1 illustrates a computing environment 100, which may be used to implement and/or execute any of the methods described herein. In some embodiments, the computing environment 100 may be implemented by any of a conventional personal computer, a computer dedicated to managing network resources, a network device and/or an electronic device (such as, but not limited to, a mobile device, a tablet device, a server, a controller unit, a control device, etc.), and/or any combination thereof appropriate to the relevant task at hand. In some embodiments, the computing environment 100 comprises various hardware components including one or more single or multi-core processors collectively represented by processor 110, a solid-state drive 120, a random access memory 130, and an input/output interface 150. The computing environment 100 may be a computer specifically designed to operate a machine learning algorithm (MLA). The computing environment 100 may be a generic computer system.

In some embodiments, the computing environment 100 may also be a subsystem of one of the above-listed systems. In some other embodiments, the computing environment 100 may be an “off-the-shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Those skilled in the art will appreciate that processor 110 is generally representative of a processing capability. In some embodiments, in place of or in addition to one or more conventional Central Processing Units (CPUs), one or more specialized processing cores may be provided. For example, one or more Graphic Processing Units (GPUs), Tensor Processing Units (TPUs), and/or other so-called accelerated processors (or processing accelerators) may be provided in addition to or in place of one or more CPUs.

System memory will typically include random access memory 130, but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 120 is shown as an example of a mass storage device, but more generally such mass storage may comprise any type of non-transitory storage device configured to store data, programs, and other information, and to make the data, programs, and other information accessible via a system bus 160. For example, mass storage may comprise one or more of a solid state drive, hard disk drive, a magnetic disk drive, and/or an optical disk drive.

Communication between the various components of the computing environment 100 may be enabled by a system bus 160 comprising one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wired or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example the networking interface may implement specific physical layer and data link layer standards such as Ethernet, Fibre Channel, Wi-Fi, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

According to some implementations of the present technology, the solid-state drive 120 stores program instructions suitable for being loaded into the random access memory 130 and executed by the processor 110 for executing acts of one or more methods described herein. For example, at least some of the program instructions may be part of a library or an application.

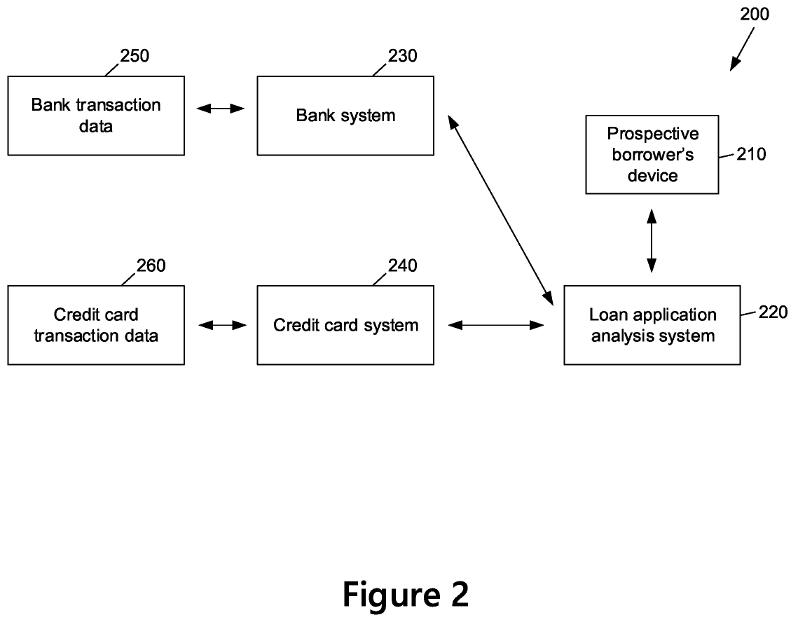

FIG. 2 is a diagram of a system 200 for evaluating a loan application. A prospective borrower may apply for a loan, such as by using a device 210. The device 210 may be a mobile device or any other type of computing environment 100. The prospective borrower may use the device 210 to complete a loan application, such as by inputting personal information identifying the prospective borrower, a requested loan amount, a duration of the loan, etc. The prospective borrower may use the device 210 to provide login credentials, for a bank system 230, credit card system 240, and/or any other accounts related to the prospective borrower. The login credentials may include as a username, an account number, and/or a password In some instances, rather than using the prospective borrower's device 210, the prospective borrower may fill out a paper application and/or use a computing environment 100 operated by the lender.

The prospective borrower's device 210 may transmit the application to a loan application analysis system 220. The loan application analysis system 220 may be operated by a lender. The loan application analysis system 220 may be communicatively coupled (e.g., via network connection, potentially through an application programming interface) to one or more financial institution systems, such as a bank system 230 and/or a credit card system 240.

After receiving the loan application, the loan application analysis system 220, may retrieve the prospective borrower's transaction history, such as a history of bank and/or credit card transactions made by the prospective borrower. Financial transaction data, data associated with one or more loans of interest, and/or other data (e.g., financial data, account data, personal identification data, etc.) may be retrieved from and/or communicated to the one or more financial institution systems.

The loan application analysis system 220 may communicate with the bank system 230 and/or the credit card system 240 to retrieve the prospective borrower's transaction history. The bank system 230 may access bank transaction data 250 to retrieve the prospective borrower's bank transaction history. Similarly, the credit card system 240 may access credit card transaction data 260 to retrieve the prospective borrower's credit card transaction history. In order to access the bank system 230 and/or credit card system 240, the loan application analysis system 220 may login to the prospective borrower's bank and/or credit card accounts using credentials submitted by the user.

The retrieved transaction history data may comprise historical banking transaction data. For example, data identifying past transactions that have taken place in a checking and/or savings account held at a bank (or generally, some other financial institution) in the name of an individual X can constitute historical banking transaction data. A historical banking transaction record might include data for one or more of the following fields, provided by way of example and without limitation: a transaction identifier and/or description (“TransactionID”), a customer identifier (“CustID”), a transaction date, a credit amount and/or a debit amount.

The loan application analysis system 220 may use the retrieved bank transaction data 250, credit card transaction data 260, and the loan application received from the prospective borrower's device 210 to generate a report recommending whether the loan application should be approved or denied. Machine learning algorithms (MLAs) may use the transaction data to generate various predictions, such as a predicted likelihood that loan will be approved and/or a predicted likelihood that the loan will be repaid. The loan application analysis system 220 may use the predictions to generate the report and/or to approve or deny the loan application.

The MLAs may be used to first build a model based on training inputs comprised of data (“training data”) in order to subsequently make data-driven predictions or decisions expressed as outputs, rather than following static computer-readable instructions. MLAs are commonly used for various prediction-like tasks based on some sets of features available as part of input data.

The implementation of the MLAs described herein can be broadly categorized into two phases—a training phase and a prediction phase. During the training phase, a given MLA may receive one or more sets of training data comprising respective training vectors and respective labels. Training vectors are usually indicative of some features that may contain some type of contextual information or that may have some effect on an output, while labels are usually indicative of that output, which is in a sense “desirable” or otherwise of interest. Therefore, labels can be said to represent target results for the given MLA to output for respective training vectors.

Subsequently, during the prediction phase, if a trained MLA receives, as “in-use” input data, a vector “similar” to a given training vector from the training data used in the training phase, the MLA may provide an output “similar” to the label of that training vector. What constitutes “similar” can differ depending on the particular MLA employed.

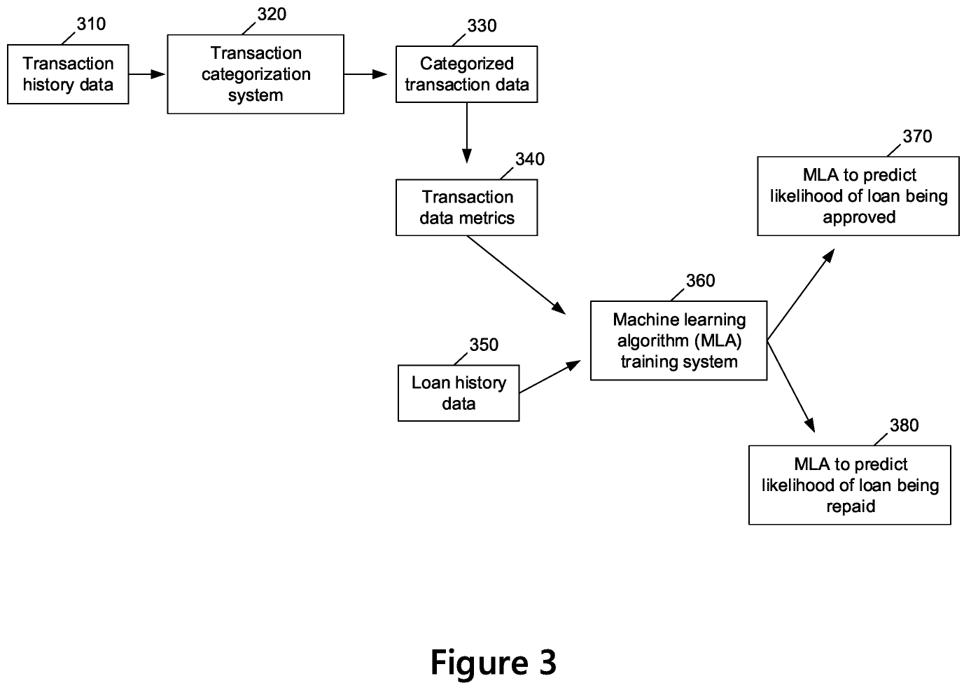

FIG. 3 is a diagram of a system for training MLAs. Training data may be used to train the MLAs. Training data generally may comprise one or more training sets where each training set comprises (i) a respective training vector and (ii) a respective label associated with the respective training vector. In at least some implementations, to train an MLA, training vectors can be generated based on a number of “features” that are either obtained directly from data potentially usable and made available for training, or derived therefrom (e.g., in a process of “feature engineering” or “feature generation”), and a label associated with that training vector may be assigned.

A training vector and associated label may be generated for each of multiple historical loans. These training vectors and associated labels may be stored in a database to train machine learning algorithms for a subsequent prediction phase. For a given historical loan, the label may be a boolean identifier (e.g., 0—no, 1—yes) that indicates whether or not the loan was repaid. The training vector may comprise a set of values computed or obtained for “features” that may, potentially, be predictive to some degree of that result—whether the loan was repaid. In one broad aspect, the features may be extracted from existing transaction history data 310 and/or loan history data 350, such as:
details of the loan (e.g., principal amount, type of loan, lender identification data, geographical data, time requested, etc.);
details of the borrower (e.g., age, gender, number of previous loans, years with financial institution, occupation, net worth, annual income, postal code, etc.);
details extracted or derived from banking transactions of the borrower (e.g., years a given account was opened, number and/or value of transactions belonging to any number of categories whether in terms of type, amount, frequency, period, etc.—some additional pre-processing may be performed to categorize historical transactions with any number of categorization schemes possible, number of anomalous transactions—potentially generated from a fraud or anomaly detection algorithm, etc.);
details associated with the application process (e.g., time to fill out an application form or certain parts thereof, etc.);
optionally, details of other loans, other borrowers, and/or other banking transactions, etc.;
etc.

The training set can comprise (i) a respective training vector that has been generated based on data associated with a given historical loan and (ii) a respective label that has been generated based on data that indicates whether that loan was repaid. The training sets may be categorized into two categories—(i) “positive” training sets, which can be associated with historical loans that have been repaid, and (ii) “negative” training sets, which can be associated with historical loans that have not been repaid.

It is notable that the above examples of features for which values are extracted, derived, or otherwise computed to populate the training vectors can vary widely in scope, and via experimentation. For example, certain features may be determined to be more highly predictive of the corresponding label than others and those features may be employed in the training phase.

Transaction history data 310 may include transaction histories for a group of people, such as people who have applied for loans. The transaction history data 310 may include numerous transactions, such as thousands or millions of transactions. Additional data may be derived, or otherwise generated, at least in part from the transaction history data 310. For example various metrics of the transaction history data 310 may be calculated.

FIG. 5, described in further detail below, illustrates an example of transaction history data. Each transaction in the transaction history data 310 may include a user ID or other identification of a user, a transaction description, an amount of the transaction, a date or timestamp corresponding to the transaction, and/or any other transaction information. The transaction history data 310 may have been retrieved from bank accounts, credit card accounts, and/or any other accounts storing financial transaction data.

The transaction history data 310 may be pre-processed for training an MLA. Various rules may be applied to the transaction history data 310. Transactions that are incomplete may be removed from the transaction history data 310, such as transactions that are missing an amount or a date. Transactions that appear to be erroneous may be removed from the transaction history data 310, such as transactions having very high or very low amounts. Duplicate transactions may be removed from the transaction history data 310. Transactions that relate to users who aren't included in loan history data 350 may be removed from the transaction history data 310. Older data may be removed by removing transactions that occurred before a threshold date from the transaction history data 310.

Transactions in the transaction history data 310 may be grouped together. This may improve the efficiency of the transaction categorization system 320, which categorizes each transaction. The transaction descriptions may be used to group transactions together. Transactions that originated from a same seller may be grouped together. For example, all transactions that are payments to Walmart may be grouped together, or all payments to a single Walmart location may be grouped together.

Each transaction in the transaction history data 310 may be categorized by a transaction categorization system 320. If the transactions were grouped together, the same category may be applied to each transaction in the group. Rather than evaluating each transaction in the group, the transaction categorization system 320 can determine a category for a single transaction in the group, or a subset of the transactions in the group, and then apply that category label to each transaction in the group.

The transactions may be categorized using rules, MLAs, or a combination of the two. The rules may include text-based rules, such as rules based on regular expressions (regex). For example a rule may include a regular expression indicating a pattern of text and a category to apply to the transaction if the transaction matches the textual pattern. The rules may be created by operators of the transaction categorization system 320.

One or more MLAs may be used by the transaction categorization system 320. The MLAs may have been trained using training data that includes labeled transaction data. The training data may include transactions and a label for each transaction, where the label is the category of the transaction. Each transaction may have been labeled by a human.

The transaction categorization system 320 may output categorized transaction data 330. The categorized transaction data may include, for each transaction in the transaction history data 310, a category corresponding to the transaction. In some instances, transactions may be labeled with multiple categories and/or some transactions might not be labeled with a category.

The transaction categorization system 320 may determine various transaction data metrics 340 after categorizing the data. These transaction data metrics 340 may be referred to as additional features for training an MLA. The transaction data metrics 340 may contain metrics for each user represented in the transaction history data 310. For each user, and for each category, a sum and a count may be included in the transaction data metrics 340. The sum may be a sum of all transaction amounts for the category. The count may be a count of the number of transactions for the category.

The transaction data metrics 340 may include metrics for each of several time periods. Metrics may be determined for each of these periods of time. For example, for each category a count and a sum may be determined for every thirty day period. The duration of the time periods may be pre-determined.

The transaction data metrics 340 and loan history data 350 may be used by the MLA training system 360 to train the MLAs. The loan history data 350 may include records describing loan applications. Each record may include a user ID or other identification of a user, a requested loan amount, an indication of whether the loan was approved or denied, a loan amount, a status of the loan, an amount that was repaid, and/or any other data relating to a loan. The loan history data 350 might include data for one of more of the following fields, provided by way of example and without limitation: a loan identifier (“LoanID”), a customer identifier (“CustID”), a loan status identifier (e.g., requested, approved, active, historical/inactive, etc.), a date, one or more amounts (e.g., loan principal, balance, interest paid, etc.), and an indication of whether the loan was repaid if applicable. The identification of the user in the loan history data 350 may be linked to transactions in the transaction history data and/or metrics for that user in the transaction data metrics 340.

Similar to the transaction history data 310, the loan history data 350 may be pre-processed. Entries in the loan history data 350 that identify users with no transactions in the transaction history data 310 may be removed. Incomplete entries, duplicate entries, entries that occurred before a threshold date, and/or entries that appear to be erroneous in the loan history data 350 may be removed.

The MLA training system 360 may use all or a portion of the categorized transaction data 330 and loan history data 350 to train an MLA. The MLA training system 360 may train an MLA 370 to predict the likelihood of a loan being granted. After being trained, the MLA 370 may receive as input a prospective borrower's loan application data and/or transaction metrics, and output a predicted likelihood that the loan application will be approved.

The MLA training system 360 may train an MLA 380 to predict the likelihood that a prospective borrower would repay a loan if it were approved. The MLA 380 may be trained using a subset of the categorized loan transaction data 330 and the loan history data 350. The loan history data 350 for loans that were approved and the categorized transaction data 330 for the users who received the approved loans may be used. Loan history data 350 for loans that were not approved might not be used to train the MLA 380, and categorized transaction data 330 for users who did not receive loans might also not be used to train the MLA 380.

Generally, the MLAs that are trained and/or deployed as described herein may comprise any one, or some combination (e.g., in an ensemble), of a number of known machine learning techniques, which may include, without limitation: linear/logistic regression models, classification models, time-series models, clustering algorithms, nearest neighbor methods, decision trees, support vector machines, graphical models, neural networks, boosting, bagging, random forests, other ensemble methods, and/or any other type of function, algorithm, and/or model. In certain implementations, some of the noted algorithms might not use specifically engineered “features.”

The MLAs 370 and 380 may be any type of MLA, such as a neural network, tree-based model (such as a gradient boosted tree generated using XGBoost), etc. The MLA 370 and/or MLA 380 may comprise multiple MLAs. Each of the multiple MLAs may be seeded differently and/or trained using different training data. After training the multiple MLAs, the same input may be provided to each MLA and each MLA may provide an output prediction. The predictions may be used to determine a final prediction, such as by averaging each of the predictions or selecting a median prediction. For example, the MLA 370 may comprise four MLAs that were trained with the same training data but seeded differently. In this example, the outputs of the four MLAs may be averaged to determine the output prediction of the MLA 370.

During the training phase of an MLA, typically numerous training iterations are performed. In a given iteration, the scoring system, such as the MLA training system 360, may retrieve a training set from the database, such as the loan history data 340 and transaction data metrics 340. The training set is associated with a historical loan and comprises a training vector and a label, both associated with the historical loan. The scoring system is then configured to input the training set into the MLA. It can be said that the MLA, in a sense, “learns” to correlate the training vector to the label; put another way, the machine learning algorithm “learns” that for the training vector, the “desired” value to be outputted is that label. This is performed so that subsequently, in the prediction phase, the trained machine learning algorithm would, when provided with an input vector similar to that training vector, generate a given output value similar to the corresponding label.

For example, if the training set is a given positive training set (providing for example, a historical loan, having certain characteristics represented by the values in the training vector, that is labelled as having been repaid), the MLA is trained so that, when it is later provided with a given vector as input (during the prediction phase) having values similar to those of the training vector (intuitively, when a new loan application has similar characteristics to the repaid historical loan), it may generate a given output value that indicates the prospective loan is likely to be repaid (e.g., “1”).

In another example, if the training set is a given negative training set (providing for example, a historical loan, having certain characteristics represented by the values in the training vector, that is labelled as having not been repaid), the MLA is trained so that, when it is later provided with a given vector as input (during the prediction phase) having values similar to those of the training vector (intuitively, when a new loan application has similar characteristics to the historical loan that was not repaid), it may generate a given output value that indicates the prospective loan is likely not to be repaid (e.g., “0”).

Known methodologies may be employed to determine the level of accuracy that a trained machine learning algorithm might be expected to have when applied to “new” or unseen data. For example, a certain amount of training data may be set aside as “test data,” which is labeled data that is not used for training, but rather used to evaluate the performance of the MLA after it has been trained. After training is complete, predictions may be generated (while disregarding the labels) from the values in the training vectors of the test data, and those predictions can then be compared to the labels (representing the “truth”) in order to obtain, for example, a measure of accuracy. This measure of accuracy may be usable as an approximation of the level of accuracy the MLA, such as the MLA 370 or 380, can expect to attain if it were to be deployed and applied to new data in the prediction phase to make predictions.

After the MLAs 370 and/or 380 have been deemed to be satisfactorily trained, they may be deployed for use in the prediction phase. During this prediction phase, an in-use vector may be generated for a loan application. This is performed in a manner similar to how training vectors had been generated for past loans: values for the same “features” represented in the training vectors are computed for the loan of interest. However, the “label” is now truly unknown, and is precisely what the trained MLA is expected to predict. In particular.

The MLA 370 may receive as input a prospective borrower's loan application data and/or transaction metrics, and output a predicted likelihood that the loan will be approved. The MLA 380 may receive as input a prospective borrower's loan application data and/or transaction metrics, and output a predicted likelihood that the prospective borrower will repay the loan. The output values of the MLAs 370 and 380 may be a given value between “0” and “1”, which, for example, may be indicative of a percentage probability (by multiplying the value by 100).

After, or instead of, generating the predicted probabilities, various types of transformations may be employed. For example, different values from a number of preset intervals or ranges in the output value may be mapped to one of a potentially set number of specific numerical scores. As a further example, each output value may be mapped to one of a potentially set number of specific letter scores (e.g., A, B, C, D, E). In this example, the letter scores may suggest to a user whether or not the loan application should be approved.

After a prediction for a given loan of interest is made, if data becomes available at a future point in time that confirms the accuracy or inaccuracy of that prediction, that additional data may be saved in the database or otherwise provided as data that may be used to retrain the same and/or other MLAs in an attempt to improve predictive accuracy. In some implementations, results might be fed immediately back as input, such as where a reinforcement learning algorithm is employed.

Although described as a loan application, in some instances the loan evaluated by the MLA 370 and/or MLA 380 may be an active loan, i.e. a loan for which funds have already been disbursed.

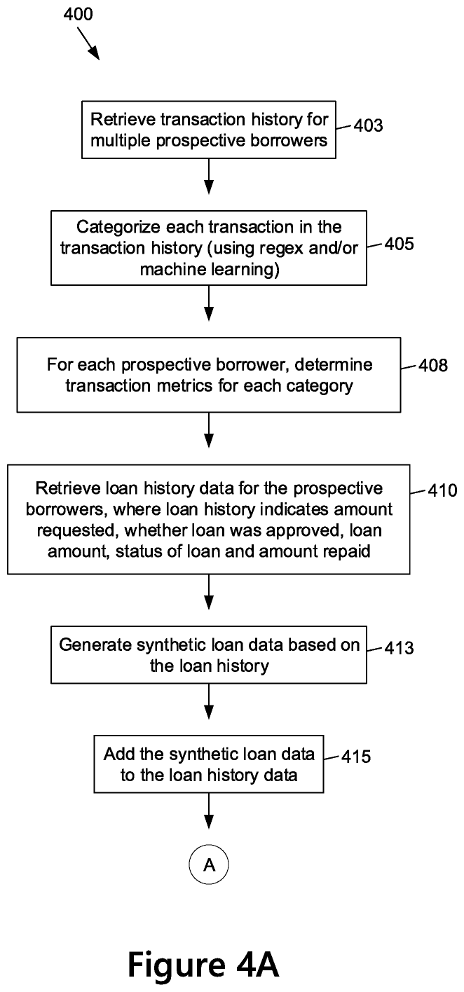

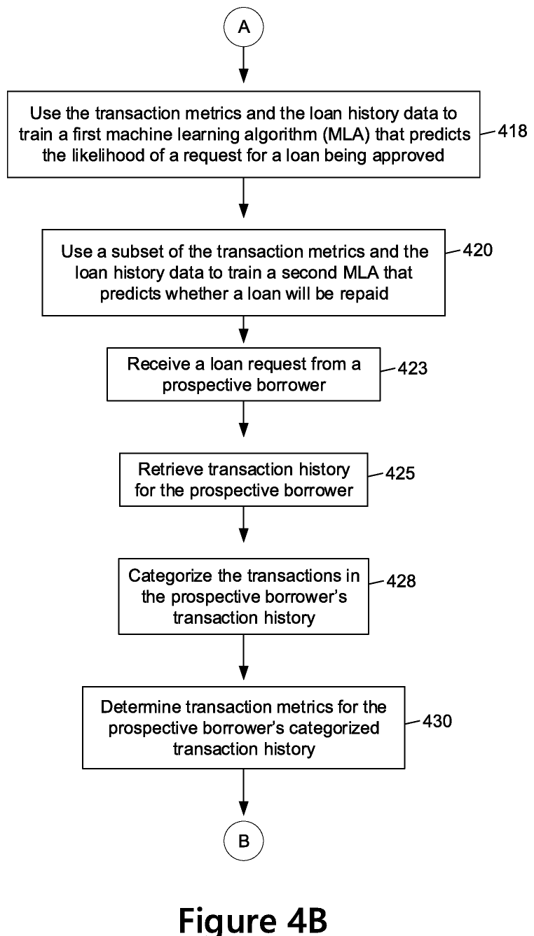

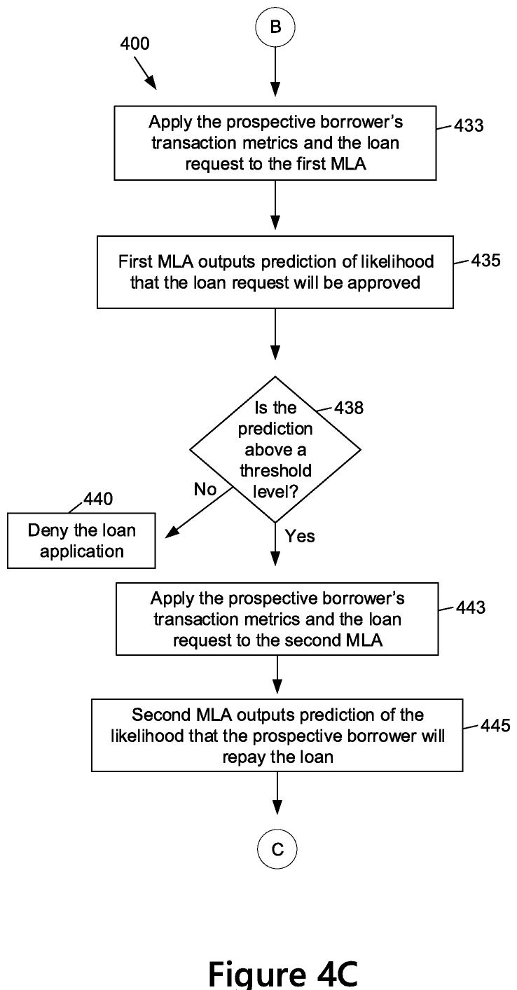

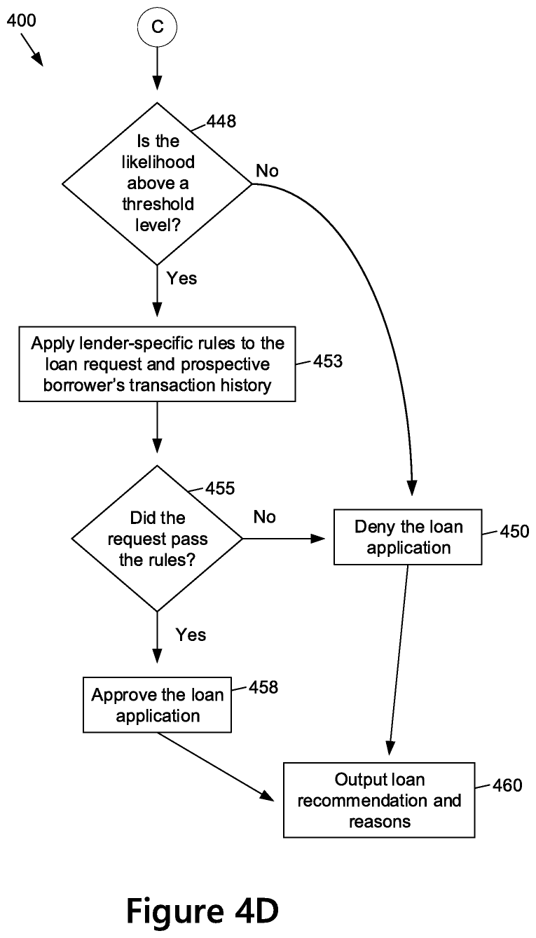

FIGS. 4A-D illustrate a flow diagram of a method 400 for evaluating loan applications in accordance with various embodiments of the present technology. In one or more aspects, the method 400 or one or more steps thereof may be performed by a computing system, such as the computing environment 100. The method 400 or one or more steps thereof may be embodied in computer-executable instructions that are stored in a computer-readable medium, such as a non-transitory mass storage device, loaded into memory and executed by a CPU. The method 400 is exemplary, and it should be understood that some steps or portions of steps in the flow diagram may be omitted and/or changed in order.

At step 403 transaction history for multiple prospective borrowers may be retrieved. For example, the transaction history data 310 may be retrieved. As described above, the transaction history may be pre-processed, such as to remove duplicate and/or incomplete entries. The transaction history may have been retrieved from bank accounts, credit card accounts, and/or any other type of account containing transaction data.

At step 405 each transaction in the transaction history may be categorized. A set of categories may be pre-determined. Each transaction may be labeled with a category, or in some instances one or more categories. As described above, some transactions may be grouped, and every transaction in the group may be labeled with the same category or categories. If the transactions are to be grouped, the transactions may first be grouped and then labeled with categories.

The transactions in the transaction history may be processed in any order. For each transaction, rules, such as rules containing regular expressions (regex), may be used to determine which category or categories to label the transaction. An MLA may be used to determine a category for a transaction. The MLA may have been trained using labeled transactions, where each transaction in the training data was labeled with a category. A combination of rules and MLAs may be used to determine a category for a transaction.

At step 408 various metrics may be determined for the transactions in the transaction history, such as the transaction data metrics 340. These metrics may be referred to as features. The metrics may be determined for each time period of multiple time periods, such as for each thirty day time period. The metrics may include a count of the number of transactions within each category that were posted to an individual's account within a specified time period. The metrics may include a sum of all transactions within each category that were posted to an individual's account within a specified time period.

At step 410 loan history data, such as the loan history data 350, may be retrieved. The loan history data may be retrieved from a database. The loan history data may include multiple entries, where each entry includes an identifier of the prospective borrower, amount requested, whether the loan was approved, a loaned amount, an amount repaid, and/or a status of the loan. As described above, the loan history data may be pre-processed, such as to remove duplicate and/or incomplete entries.

At step 413 synthetic loan history data may be generated. In some instances, MLAs generated using the method 400, such as the MLAs 370 and 380, may predict that a loan is more likely to be granted and/or repaid as the requested loan amount is increased. This behavior of the MLAs might not be desirable. Rather, the predicted likelihood of repayment should either remain constant or decrease as the requested loan amount increases. Typically, lenders will approve loans of relatively larger amounts in instances where the lender is highly likely to be repaid, such as if the loan is for a borrower that has previously repaid their loans. Because these loans with higher amounts are more likely to be granted and/or repaid, the MLAs may be skewed. In order to counteract this effect, synthetic loan history data may be generated.

Synthetic loan history data may be generated for each approved loan in the loan history data. If a loan was repaid, it can be assumed that the same loan, had it been approved with a lower loan amount, would also have been repaid. Similarly, for each loan that was not repaid, it can be assumed that the same loan, had it been approved for a higher loan amount, also wouldn't have been repaid. Synthetic loan data may be generated based on these assumptions.

For each approved loan that was repaid, synthetic loan data may be generated for amounts lower than the amount of the loan. All of the other data in the entry for the loan that was repaid may be copied, but the loan amount may be changed to a lower amount. For example if a $750 loan was repaid, synthetic loan data may be generated for a $500 loan and a $250 loan. In this example, the three loans may be identical in all aspects other than the loan amount (same borrower, same transaction data metrics, etc.). The amount of synthetic loans generated for each actual loan and the intervals between loan amounts may be pre-determined and/or determined based on rules.

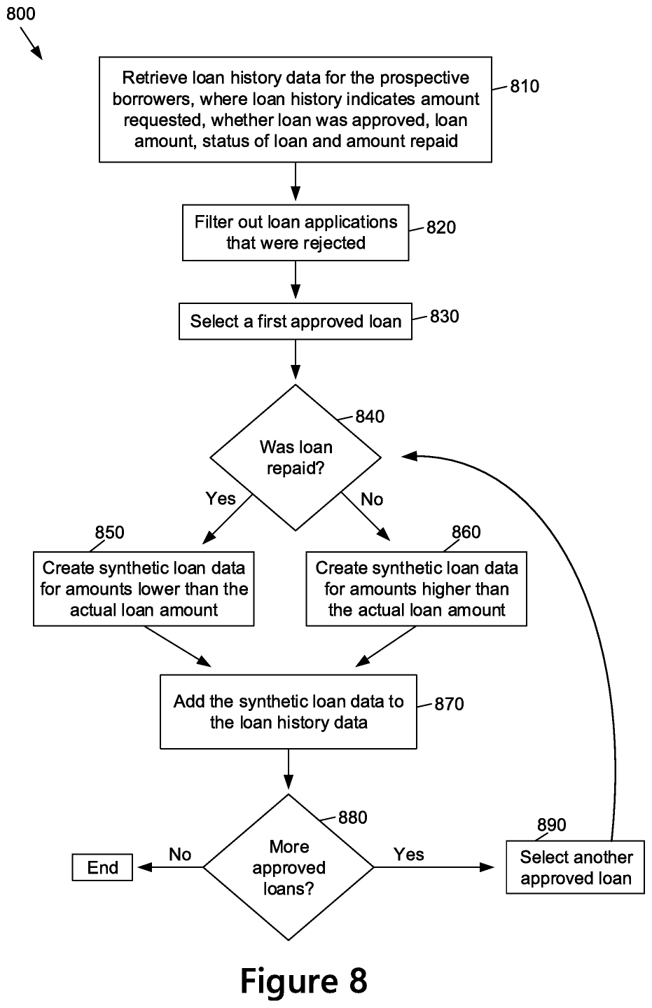

For each approved loan that was not repaid, synthetic loan data may be generated for amounts greater than the amount of the loan. For example if a $200 loan was not repaid, synthetic loan data may be generated for a $500 loan, a $1,000 loan, and a $2,000 loan. The method 800, described in FIG. 8 and in further detail below, is an example of a method for generating synthetic loan data.

At step 415 the synthetic loan data may be added to the loan history data retrieved at step 410. Steps 403-15 describe generating training data for training an MLA, such as the MLAs 370 and 380. The steps 403-15 describe an exemplary method of generating training data, but many other methods may be used.

At step 418 the transaction data and the loan history data may be used to train a first MLA that predicts the likelihood of a request for a loan being approved, such as the MLA 370. The first MLA may be trained using all or a portion of the loan history data and the synthetic loan data. The first MLA may be trained using all or a portion of the transaction data metrics stored at step 408. The transaction data metrics and the loan history data may be correlated by user ID.

For each entry in the loan history data, the MLA may be provided the loan history data entry and the transaction data metrics for the individual identified in the loan history data entry. Based on the amount requested for the loan and the transaction data metrics for the individual, the MLA may predict a likelihood that the loan will be approved. The MLA may then compare the prediction to whether the loan was approved or not, as indicated in the loan history data. The MLA may then adjust itself accordingly to improve future predictions.

The first MLA may be determined to be sufficiently trained after receiving a threshold amount of training data, making predictions within a threshold accuracy, and/or based on other criteria. After being trained, the first MLA may receive loan application data and transaction data metrics, and output a predicted likelihood that the loan application will be approved. The predicted likelihood may be in a percentage format.

At step 420 a second MLA, such as the MLA 380, may be trained to predict the likelihood that a loan will be repaid if it is approved. The second MLA may be trained using a subset of the transaction data metrics and the loan history data. The subset may include entries in the loan history data that describe approved loans. The subset may also include transactions data metrics corresponding to the individuals who received the approved loans.

For each entry in the subset of the loan history data, the second MLA may be provided the entry in the loan history data and the transaction data metrics for the individual identified in the loan history data entry. The second MLA may predict the likelihood that the loan was repaid. The second MLA may then compare the prediction to whether the loan was repaid or not, which is indicated in the loan history data. The second MLA may then adjust itself based on whether or not the prediction was correct.

Like the first MLA, the second MLA may be determined to be sufficiently trained after receiving a threshold amount of training data, making predictions within a threshold accuracy, and/or based on other criteria. After being trained, the second MLA may receive loan application data and transaction data metrics for the prospective borrower, and output a predicted likelihood that the loan will be repaid if it is approved. The predicted likelihood may be in a percentage format. After training the first and second MLAs at steps 418 and 420, the MLAs may be ready to make predictions.

At step 423 a loan request may be received from a prospective borrower. The prospective borrower may have completed the loan request using a computing environment 100, such as the prospective borrower's device 210. The loan request may include a requested loan amount, information identifying the prospective borrower, account information for accessing the prospective borrower's financial accounts, and/or other information.

At step 425 the transaction history for the prospective borrower may be retrieved. The prospective borrower's credit card transactions, bank account transactions, and/or any other financial transactions may be retrieved. The transactions may be retrieved by accessing the prospective borrower's accounts, such as by logging into the prospective borrower's bank account. The transaction history may be retrieved for a pre-determined period. For example all transactions that occurred over the past ninety days may be retrieved.

At step 428, each transaction in the prospective borrower's transaction history may be categorized. Each transaction in the prospective borrower's transaction history may be labeled with one or more categories. The transactions may be categorized using regex-based rules and/or an MLA. The transactions in the prospective borrower's transaction history may be categorized in a same or similar manner to the way that the transactions in the training data were categorized at step 405. Like the transactions categorized at step 405, the transactions in the prospective borrower's transaction history may be grouped before being categorized.

At step 430, transaction data metrics may be determined based on the prospective borrower's categorized transaction data. The prospective borrower's categorized transaction data may be split into various periods, such as thirty day periods, and the metrics may be determined for each of the periods. The metrics may include a count of transactions that occurred for each category during each period and/or a sum of the amounts of transactions that occurred for each category during each period. The metrics determined at step 430 may be the same as the metrics determined at step 408, and they may be determined in a same or similar manner.

At step 433 the loan request and the transaction data metrics may be input to the first MLA. All or a portion of the transaction data metrics and/or loan request may be input to the first MLA. For example the requested loan amount and the transaction data metrics for the past six months may be input to the first MLA

At step 435 the first MLA may output a predicted likelihood that the loan request will be approved. The prediction may be output as a percentage likelihood. In some instances multiple MLAs may be used at steps 433 and 435. The results of the multiple first MLAs may then be used to determine a prediction, such as by averaging the results of each of the first MLAs.

At step 438 the prediction output by the first MLA may be compared to a threshold percentage. The threshold percentage may be pre-determined. The threshold percentage may be specific to a lender and/or may be selected by the lender. Although described as a percentage, the threshold may be in any other format that can be compared to the prediction that is output by the first MLA.

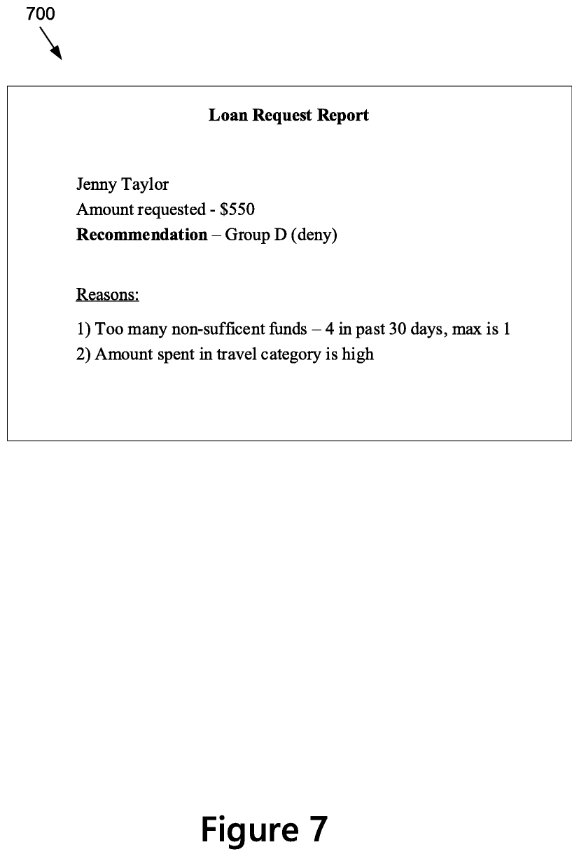

If the prediction is below the threshold percentage, the loan application may be denied at step 440. A recommendation to deny the loan application may be output. An explanation for the denial may be output. Variable importance may be determined for the first MLA. In other words, the features used by the first MLA may be ranked based on how much they affect predictions made by the first MLA. The output may include some of the features with the highest rankings to explain why the loan application was denied. FIG. 7, described in further detail below, includes an example output with explanation.

If the prediction is determined to be above the threshold at step 438, at step 443 the prospective borrower's transaction data metrics and/or loan request data may be input to the second MLA. All or a portion of the transaction data metrics and/or loan request data may be input to the second MLA.

At step 445 the second MLA may output the prediction of the likelihood that the prospective borrower will repay the loan. The prediction may be in the format of a percentage. In some instances multiple MLAs may be used at steps 443 and 445. The results of the multiple second MLAs may then be used to determine a prediction, such as by averaging the results of each of the second MLAs.

At step 448 the prediction from step 445 may be compared to a threshold percentage. The threshold percentage may be pre-determined. The threshold percentage may be specific to a lender and/or may be selected by the lender. If the prediction fails to satisfy the threshold, in other words if the prediction is below the threshold, the loan application may be denied at step 450 and/or a recommendation to deny the loan may be output at step 460. Actions performed at steps 450 and 460 may be similar to those performed at step 440.

If the predicted likelihood that the loan will be repaid is determined to satisfy the threshold at step 448, in other words if the predicted likelihood is above the threshold level, lender-specific rules may be applied at step 453. The lender-specific rules may be created and/or selected by a lender.

The lender-specific rules may use as inputs data in the loan application, the prospective borrower's transaction history, the prospective borrower's categorized transaction history, the prospective borrower's transaction data metrics, and/or other data relating to the prospective borrower. For example, one rule may indicate that all loan applications should be denied for any prospective borrower having two or more transactions denied for non-sufficient funds within the last thirty day period.

At step 455 a determination may be made as to whether the loan application satisfies the lender-specific rules. If the application failed any of the lender-specific rules, the loan application may be denied at step 450 and/or a recommendation to deny the loan application may be output at step 460. As an explanation for the recommendation, the recommendation may include a description of any rules that the request failed to satisfy.

If the loan application is determined to satisfy the rules at step 455, the loan application may be approved at step 458 and/or a recommendation to approve the loan may be output at step 460. Reasons that the loan was approved may also be output at step 460. The reasons may be determined based on the feature importance of the first and/or second MLAs.

FIG. 5 illustrates an example of transaction history data. For each transaction, a transaction description is included in the left column and an amount is included in the right column. The amount may indicate whether the transaction was a credit or a debit. The transaction description indicates the different types of transactions, such as point of sale transactions that occur in retail stores, internet banking transactions that occur online, and branch transactions that are associated with banks. These transaction descriptions are exemplary, and it should be understood that many other types of transaction descriptions exist.

The transaction descriptions may be used to categorize the transactions. For example the overdraft fee transaction may be labelled with a “bank fees” category and/or a “non-sufficient funds” category. As described above, regex rules may be applied to the transaction description to determine a category to label the transaction. The transaction description may be input to an MLA to determine a category to label the transaction

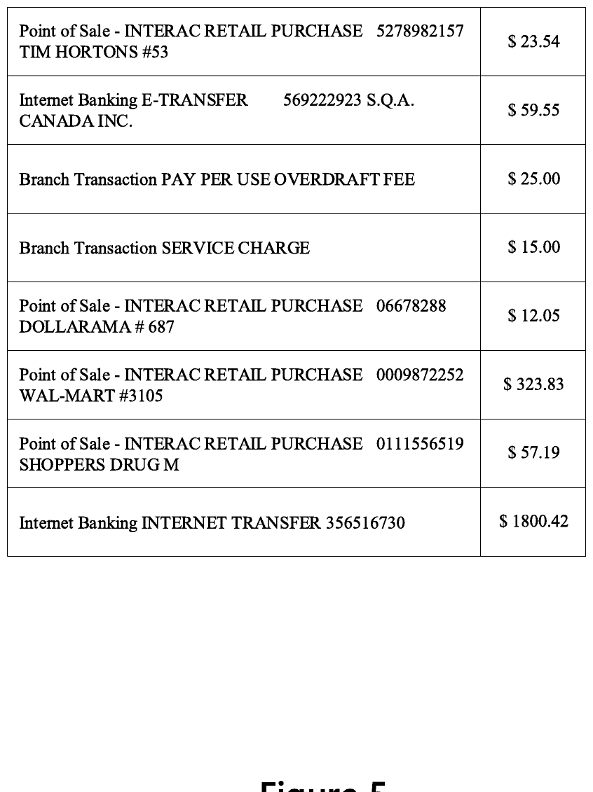

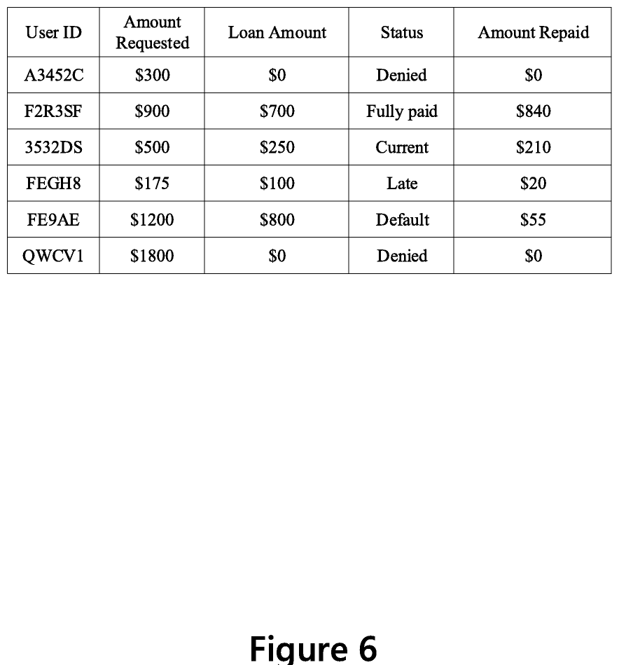

FIG. 6 illustrates an example of loan history data. The loan history data includes multiple entries, with one entry per row. Each row corresponds to an individual loan application. Each entry includes a user ID, amount requested, loan amount, status of the loan, and an amount repaid. It should be understood that these data types are exemplary, and that some or all of the illustrated categories of data might not be included in the loan history data and/or may be stored in a different format. Other information may be included in the loan history data, such as a date for each loan.

The user ID identifies the prospective borrower who requested the loan. The user ID may be used to identify transaction history data associated with the user. The amount requested is the amount that the prospective borrower requested to borrower. The loan amount is the amount that was actually disbursed to the borrower. If the loan was denied, the loan amount is zero. The status indicates the current status of the loan, such as fully paid, current if the borrower is up to date on payments, late if the borrower has missed one or more payments, denied if the loan application was not approved, and default if the borrower has defaulted on the loan. The amount repaid indicates the total amount that the borrower has repaid on the loan.

FIG. 7 illustrates an example of a loan report output 700. The loan report output 700 may be sent to and/or displayed to a lender. The loan report output 700 is an example of an output that may be displayed at steps 440 and/or 460 of FIGS. 4C and 4D. It should be understood that the loan request report 700 is exemplary, and that the report may be presented in other formats and/or include different information.

The exemplary loan request report 700 includes a name of the prospective borrower. Any other identifier of the prospective borrower may be used, such as an anonymized user ID. The report 700 includes the amount that the prospective borrower requested for the loan. The report 700 includes a recommendation, such as whether to approve or deny the application. Based on the prediction of the first MLA and/or second MLA, the prospective borrower may be assigned a group. The group may indicate the likelihood that the user will repay a loan. In the report 700 the user has been assigned “Group D,” which indicates a low likelihood to repay the loan and thus the recommendation is to deny the loan application.

The report 700 includes two reasons for the recommendation to deny the loan application. The reasons may be determined based on feature importance to one of the MLAs used for the recommendation. The reasons may include a lender-specific rule that the loan and/or prospective borrower's transaction history violated.

In the exemplary report 700, the first reason is based on a lender-specific rule. The lender had a rule that at most one transaction in the past 30 days could be rejected for non-sufficient funds. The prospective borrower in this example had four transactions rejected for non-sufficient funds, violating the rule. The second rule in the exemplary report 700 is based on feature importance. The feature importance for the first and/or second MLA indicated that the amount spent in a “travel” category has a relatively large effect on the predictions of the first and/or second MLA. The prospective borrower had a high total amount of spending in the “travel” category, which is another reason why the report 700 recommends that the loan application be denied.

FIG. 8 illustrates a flow diagram of a method 800 for generating synthetic loan history data in accordance with various embodiments of the present technology. In one or more aspects, the method 800 or one or more steps thereof may be performed by a computing system, such as the computing environment 100. The method 800 or one or more steps thereof may be embodied in computer-executable instructions that are stored in a computer-readable medium, such as a non-transitory mass storage device, loaded into memory and executed by a CPU. The method 800 is exemplary, and it should be understood that some steps or portions of steps in the flow diagram may be omitted and/or changed in order.

At step 810 loan history data for prospective borrowers may be retrieved. Actions taken at step 810 may be similar to those described above with regard to step 410 of FIG. 4A. The loan history data may be retrieved by querying a database. The query may include a period of time, such as a maximum age of the loan data to return in response to the query. FIG. 6 illustrates an example of the loan history data that may be retrieved.

At step 820 entries in the loan history data that represent loans that were denied may be removed from the loan history data. If the loan history is retrieved by querying a database, the query may indicate that loan history data representing denied loans should not be returned in response to the query. Any loans that have do not have a status indicating that the loan was either repaid, current, late, or default may be removed from the loan history data.

At step 830 a first approved loan may be selected from the loan history data. The approved loans may be selected in any order. At step 840 a determination may be made as to whether the loan was repaid. The determination may be made based on the status of the loan and/or the amount repaid.

If the loan was repaid, at step 850 synthetic loan data for amounts lower than the loan amount may be generated. The amount of synthetic loan entries to generate may be pre-determined and/or determined based on a formula. The loan amount may be reduced by a pre-determined amount until the amount reaches zero.

If the loan was not repaid, such as if the loan is in default, synthetic loan data for amounts higher than the loan amount may be generated at step 860. For the synthetic loan data generated at step 860, the loan amount may be increased by a pre-determined amount and/or based on a pre-determined formula. A maximum amount for the synthetic loan data generated at step 860 may be defined and/or a maximum number of synthetic loan entries to generate may be defined. At step 850 or 860, the generated synthetic loan data may be identical to the approved loan except that the loan amount may be altered.

After generating the synthetic loan data at step 850 or 860, the synthetic loan data may be added to the loan history data at step 870. At step 880 a determination may be made as to whether there are additional approved loans in the loan history data to process. If there are no more loans, the method 800 may end. If there are more approved loans, a next loan may be selected at step 890 and then synthetic loan data may be generated for that loan beginning again at step 840.

While some of the above-described implementations may have been described and shown with reference to particular acts performed in a particular order, it will be understood that these acts may be combined, sub-divided, or re-ordered without departing from the teachings of the present technology. At least some of the acts may be executed in parallel or in series. Accordingly, the order and grouping of the act is not a limitation of the present technology.

It should be expressly understood that not all technical effects mentioned herein need be enjoyed in each and every embodiment of the present technology.

As used herein, the wording “and/or” is intended to represent an inclusive-or; for example, “X and/or Y” is intended to mean X or Y or both. As a further example, “X, Y, and/or Z” is intended to mean X or Y or Z or any combination thereof.

The foregoing description is intended to be exemplary rather than limiting. Modifications and improvements to the above-described implementations of the present technology may be apparent to those skilled in the art.

1. A method comprising:
receiving, from a user, a request for a loan, wherein the request comprises a loan amount;
retrieving a description of a plurality of transactions performed by the user;
determining, for each transaction of the plurality of transactions, one of a plurality of categories corresponding to the respective transaction;
determining, for each category of the plurality of categories, a total amount spent corresponding to the respective category and a total amount of transactions corresponding to the respective category;
determining, by a first machine learning algorithm (MLA) and based on the loan amount, the total amount spent in each category, and the total amount of transactions for each category, a predicted likelihood that the loan will be approved,
wherein the first MLA was trained based on loan data corresponding to a plurality of users and transaction data corresponding to the plurality of users;
determining, by a second MLA and based on the loan amount, the total amount spent in each category, and the amount of transactions for each category, a predicted likelihood that the loan will be repaid,
wherein the second MLA was trained based on the loan data corresponding to the plurality of users and the transaction data corresponding to the plurality of users;
determining whether to approve the request for the loan based on the predicted likelihood that the loan will be approved and the predicted likelihood that the loan will be repaid; and
outputting an indication of whether the loan was approved.

2. The method of claim 1, wherein the description of the plurality of transactions comprises a description of bank account transactions.

3. The method of claim 1, wherein the description of the plurality of transactions comprises a description of credit card transactions.

4. The method of claim 1, wherein the description of the plurality of transactions comprises an indication of a merchant for each transaction in the transaction history.

5. The method of claim 4, wherein determining the one of the plurality of categories corresponding to each transaction comprises determining, based on the indication of the merchant of the respective transaction, a category of the respective transaction.

6. The method of claim 1, wherein determining the one of the plurality of categories corresponding to each transaction comprises applying one or more regular expression (regex) rules to the description of each transaction of the plurality of transactions.

7. The method of claim 1, wherein the loan data corresponding to the plurality of users comprises a description of a plurality of loans, and wherein the description of each loan of the plurality of loans comprises an identifier of a recipient of the loan, an amount of the loan, and an indication of a status of the loan.

8. The method of claim 1, further comprising determining to approve the request for the loan after determining that the predicted likelihood that the loan will be approved is above a pre-determined threshold likelihood.

9. The method of claim 1, further comprising determining to approve the request for the loan after determining that the predicted likelihood that the loan will be repaid is above a pre-determined threshold likelihood.

10. The method of claim 1, further comprising applying a pre-determined merchant-specific rule to the description of the plurality of transactions performed by the user.

11. The method of claim 10, further comprising denying the request for the loan after determining that the merchant-specific rule is violated.

12. The method of claim 1, wherein the first MLA comprises a plurality of MLAs, and wherein determining the predicted likelihood that the loan will be approved comprises determining an average of the output of each of the plurality of MLAs.

13. The method of claim 1, wherein the second MLA comprises a plurality of MLAs, and wherein determining the predicted likelihood that the loan will be repaid comprises determining an average of the output of each of the plurality of MLAs.

14. A method comprising:
receiving, from a user, a request for a loan, wherein the request comprises a loan amount;
retrieving a description of a plurality of transactions performed by the user;
determining, for each transaction of the plurality of transactions, one of a plurality of categories corresponding to the respective transaction;
determining, for each category of the plurality of categories, a total amount spent corresponding to the respective category and a total amount of transactions corresponding to the respective category;
determining, by a first machine learning algorithm (MLA) and based on the loan amount, the total amount spent in each category, and the total amount of transactions for each category, a predicted likelihood that the loan will be approved,
wherein the first MLA was trained based on loan data corresponding to a plurality of users and transaction data corresponding to the plurality of users;
determining, by a second MLA and based on the loan amount, the total amount spent in each category, and the amount of transactions for each category, a predicted likelihood that the loan will be repaid,
wherein the second MLA was trained based on the loan data corresponding to the plurality of users and the transaction data corresponding to the plurality of users;
determining, based on the predicted likelihood that the loan will be approved and the predicted likelihood that the loan will be repaid, a recommendation to approve or deny the loan; and
outputting for display the recommendation.

15. The method of claim 14, further comprising:
determining a feature importance ranking for the first or second MLA; and
outputting, based on the feature importance ranking, an explanation for the recommendation.

16. The method of claim 14, further comprising filtering out loan applications that were denied from the loan data corresponding to the plurality of users, thereby generating filtered loan data, and wherein the second MLA was trained using the filtered loan data.

17. A method for training a machine learning algorithm (MLA) to predict the likelihood that a loan will be repaid, the method comprising:
retrieving historic loan data corresponding to a plurality of users, each entry in the historic loan data indicating a loan amount, a status of the loan, and an identifier of a user of the plurality of users;
retrieving historic transaction data corresponding to the plurality of users, each transaction in the historic transaction data indicating an amount of the respective transaction and a description of the respective transaction;
determining, for each transaction in the historic transaction data, a category, of a plurality of categories, corresponding to the respective transaction, thereby generating categorized historic transaction data;
determining, based on the categorized transaction data, transaction data metrics for each user of the plurality of users, wherein the transaction data metrics comprise a count of transactions and a sum of transaction amounts for each category of the plurality of categories; and
training, based on the historic loan data and the transaction data metrics, the MLA.

18. The method of claim 17, wherein the MLA receives as input a loan amount and transaction metrics corresponding to a prospective borrower and outputs the predicted likelihood that the loan will be repaid.

19. The method of claim 17, further comprising, grouping, based on transaction descriptions, transactions in the historic transaction data.

20. The method of claim 19, wherein a group of transactions correspond to a same retailer, and further comprising labeling each transaction in the group of transactions with a same category.
